(19) United States
(12) Patent Application Publication
(10) Pub. No.: US 2023/0072623 A1
(43) Pub. Date: Mar. 9, 2023

(54) Artificial Reality Device Capture Control and Sharing

(71) Applicant: Meta Platforms Technologies, LLC, Menlo Park, CA (US)

(72) Inventors: Andrea ZELLER, Bothell, WA (US); Oscar MURILLO, Redmond, WA (US); Matthew James SCHOENHOLZ, Seattle, WA (US)

(21) Appl. No.: 17/466,551

(22) Filed: Sep. 3, 2021

(51) Int. Cl. G06T 19/00; G06K 9/00; G06T 17/05; G06T 15/20

(52) U.S. Cl. CPC G06T 19/006; G06K 9/00362; G06T 17/05; G06T 15/20

(57) ABSTRACT

Aspects of the present disclosure are directed to an artificial reality capture and sharing system. The artificial reality capture and sharing system can provide an output view showing a world-view from an artificial reality device or a view of the user's point-of-view. The world-view can show the complete surrounding area that is being captured by the artificial reality capture and sharing system, whether or not the user of the artificial reality device is viewing that portion of the surroundings. The point-of-view version can show the portion of the surrounding area that is in the artificial reality device's display area. The artificial reality capture and sharing system can also apply filters to people depicted in its captured sensor data. This can include applying filters to identified users in on-device or shared output views or to live views of people in the surrounding area of the artificial reality device.

### TECHNICAL FIELD

The present disclosure is directed to controlling how artificial reality devices capture and share surroundings information.

### BACKGROUND

A number of artificial reality systems exist with an array of input sensors that can capture a host of information about the area surrounding the artificial reality device. Users are often aware that their devices include an array of cameras and other sensors, however they tend to have difficulty understanding exactly what these sensors capture of the user's surroundings. For example, an artificial reality device may include an array of RGB cameras that capture a 360 degree view around the artificial reality device, depth cameras or other depth sensing devices that map the shape of objects around the artificial reality device, an array of microphones that can determine tone, direction, and positioning of audio in the area, etc. However, an artificial reality device user may not know which areas around her are being captured or at what resolution. Further, other people in the area of the artificial reality device may not be aware of what aspects of themselves are being captured and/or may not have control over how the artificial reality device views and presents them.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing output views illustrating the captured sensor data of an artificial reality device.

FIG. 6 is a flow diagram illustrating a process used in some implementations for adding person filters to captured sensor data.

FIG. 7 is a conceptual diagram illustrating an example of a world-view version of an output view from an artificial reality device.

FIG. 8 is a conceptual diagram illustrating an example of a point-of-view version of an output view from an artificial reality device.

FIG. 9A is a conceptual diagram illustrating a first example of a person filter modifying the view of people captured by an artificial reality device.

FIG. 9B is a conceptual diagram illustrating a second example of a person filter modifying the view of a person captured by an artificial reality device.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to an artificial reality capture and sharing system that can control how an artificial reality device captures and shares surroundings information. The artificial reality capture and sharing system can provide an output view showing a world-view from the artificial reality device or a view of the user's point-of-view. The world-view can show the complete surrounding area that is being captured by the artificial reality capture and sharing system, whether or not the user of the artificial reality device is viewing that portion of the artificial reality device's surroundings. The point-of-view version can show the portion of the surrounding area, captured by the artificial reality capture and sharing system, that is in the display area of the artificial reality device (i.e., the area viewable by the artificial reality device user). The output view created by the artificial reality capture and sharing system can be provided to a user of the artificial reality device (e.g., to see how the artificial reality device is capturing the surrounding area outside her point-of-view) or can be shared to a third party such as by casting the output view to another display or uploading the output view to a repository that can be accessed by authorized users. In some cases, multiple output views from the same area can be combined, e.g., so another user can understand which areas any device in the vicinity is capturing. As an example, a viewing user may visit a capture hub while at a café where several users are using artificial reality devices. Each artificial reality device can provide a word-view output view with a 3D mesh of the surroundings that are being captured by that artificial reality device. These meshes can be combined into a single mesh that the viewing user can explore, thereby determining how the surrounding artificial reality devices see that area.

In some implementations, a world-view output view can be based on a reconstruction of the surrounding environment created by the artificial reality device. For example, the artificial reality device may use various sensors (e.g., cameras, depth sensors, etc.) to determine spatial information about the surrounding area of the artificial reality device. From this spatial information, the artificial reality device can create a three dimensional (3D) representation or “mesh” of the surrounding area. For example, the mesh can be a point cloud or structured light representation illustrating measured depths to points on various objects in the surrounding area. In some cases, the world-view output view can be a view into this 3D representation flattened from the position of the artificial reality device. For example, a virtual camera can be placed into a 3D model of the surrounding area, as captured by the artificial reality device, which can take images from various angles at that position, which can be used to create a panoramic image of the depth information. This panoramic image can be used as the world-view output view.

In some implementations, a point-of-view output view can be provided, by the artificial reality capture and sharing system, that shows only the surrounding area that is being viewed by the artificial reality device user. For example, an artificial reality device user may want to share her view of the world to another user and can select that other user and cast her view to a viewing device see by that other user. To achieve this, the artificial reality capture and sharing system may select or filter the sensor data to exclude captured sensor data depicting areas outside the artificial reality device user's point-of-view. The artificial reality capture and sharing system can also apply filters to control how it shows people depicted in its captured sensor data. This can include applying filters to identified users in on-device or shared output views (discussed above) or applying filters to live views of people in the surrounding area as seen through the artificial reality device. The artificial reality capture and sharing system can identify people in captured sensor data (e.g., through facial recognition) and identify and tag them. This can include tracking the tagged user's location while it is in the area captured by the artificial reality device as the artificial reality device and the users move about. The artificial reality capture and sharing system can compare the determined user identities to a filter list specifying filters to apply to specific people (as defined by those people or by the artificial reality device user) or apply filters to people with certain characteristics (e.g., the artificial reality device user's friends on a social graph or people that are not the focus of the artificial reality device user's attention). The filter list can also specify which type of filter to user—such as a face blurring effect, a color highlighting effect, an effect to overlay a graphic, etc. When such a person is identified for a filter, the artificial reality capture and sharing system can apply the filter to the view of the user—as viewed by the artificial reality device user or in the output view shared by the artificial reality capture and sharing system.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Some existing artificial reality systems capture both point-of-view and surrounding sensor data, they generally fail to communicate to either the artificial reality device user or surrounding users what is in the sensor data, nor do they allow users any control over how this information is shared or whether or how people are depicted in this data. The artificial reality capture and sharing system described herein is expected to overcome these limitations of existing artificial reality systems by constructing output views illustrating either the sensor data in the point-of-view of the artificial reality device user or a world-view reconstruction of the entire surrounding area that the artificial reality device is capturing. By providing these output views to either the user of the artificial reality device or third-parties (with associated privacy and authentication controls) the artificial reality capture and sharing system allows users to understand how the artificial reality device works and what data is being gathered. Thus, artificial reality device users become more familiar with, and better operators of, the artificial reality device; while external users become more comfortable with these devices and what they capture. This is particularly true when the external users come to understand that the captured environment data may be more focused on the depths and shape of objects in the area, as opposed to a video-quality stream of them and their activities. In addition, the artificial reality capture and sharing system can allow the artificial reality device user and/or other users to control what sensor data is stored and/or how people are depicted. By recognizing users in captured sensor data and applying filters established for individuals or for classifications of users, the artificial reality capture and sharing system can increase privacy, provide enhancements for depicted people (e.g., friend or other status indicators, focus reminders such as to bring the user's attention to users they may want to interact with, etc.), and make interactions with people such as to select them or share items with them faster and more accurate.

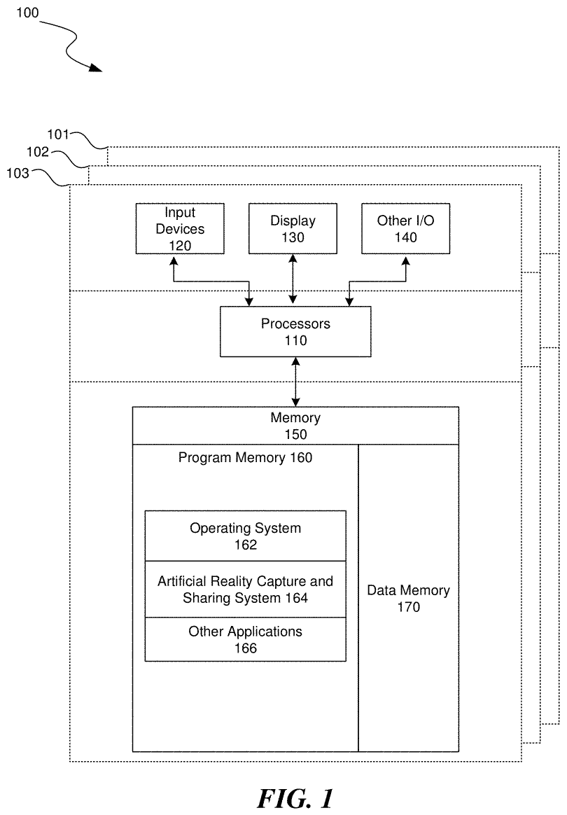

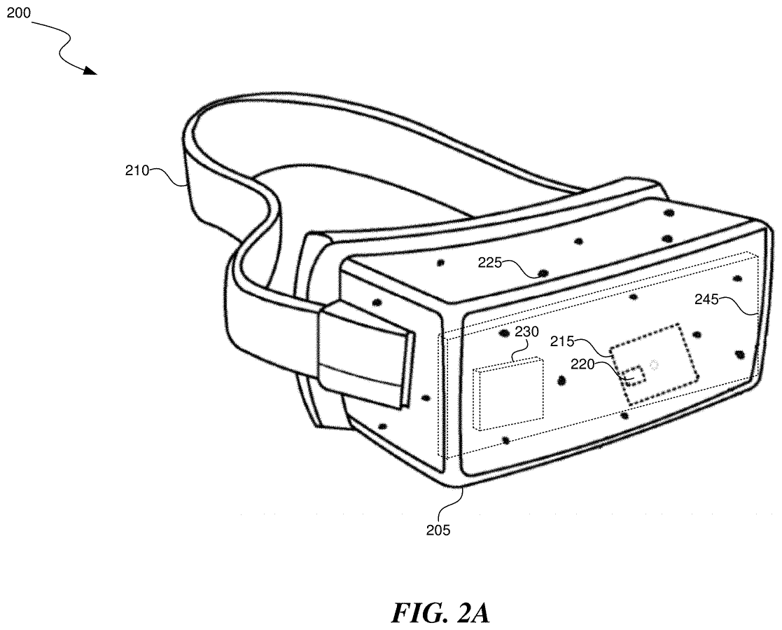

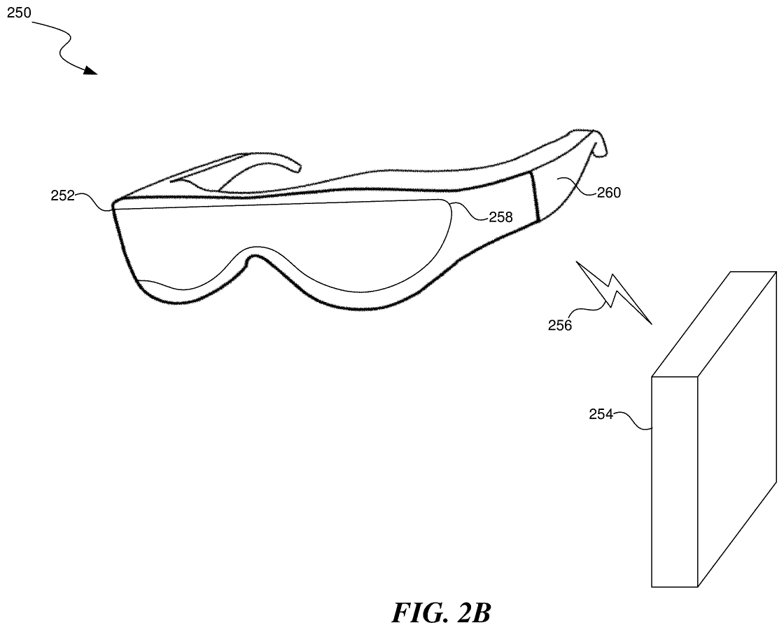

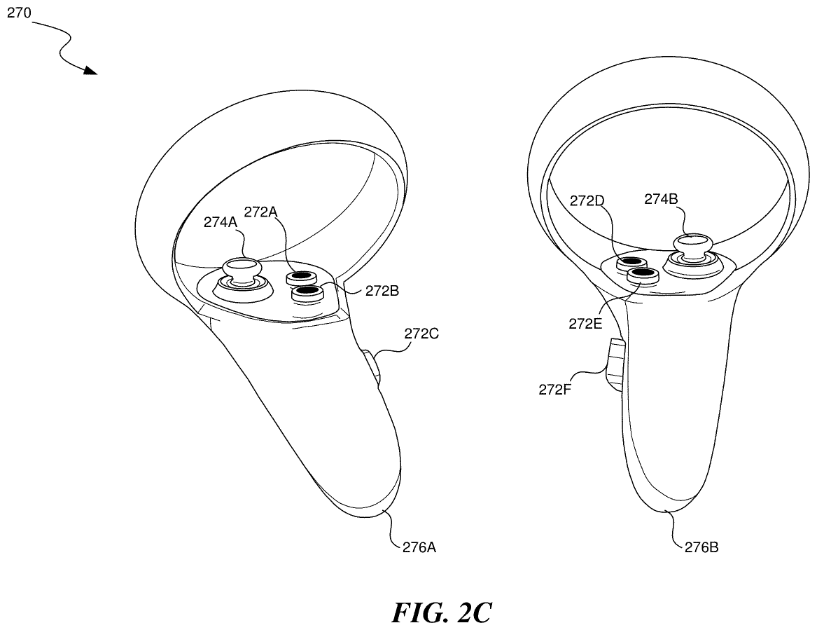

Several implementations are discussed below in more detail in reference to the figures. FIG. 1 is a block diagram illustrating an overview of devices on which some implementations of the disclosed technology can operate. The devices can comprise hardware components of a computing system 100 that can control how an artificial reality devices captures and shares surroundings information. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, artificial reality capture and sharing system 164, and other application programs 166. Memory 150 can also include data memory 170 that can include sensor data, output views, output view privacy or authorization settings, user identifiers, filters, filter lists, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in a virtual environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270, which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

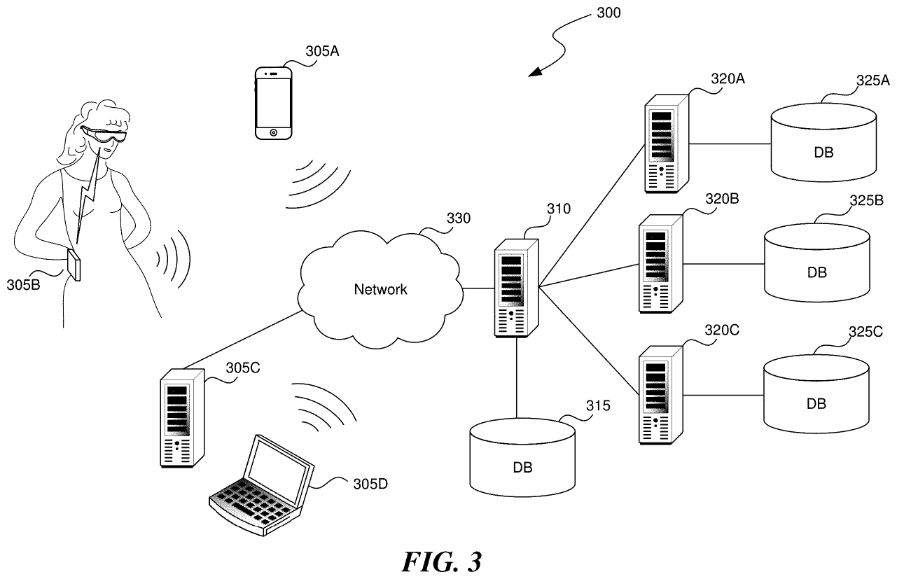

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

In some implementations, servers 310 and 320 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their personalized avatar) with objects or other avatars in a virtual environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

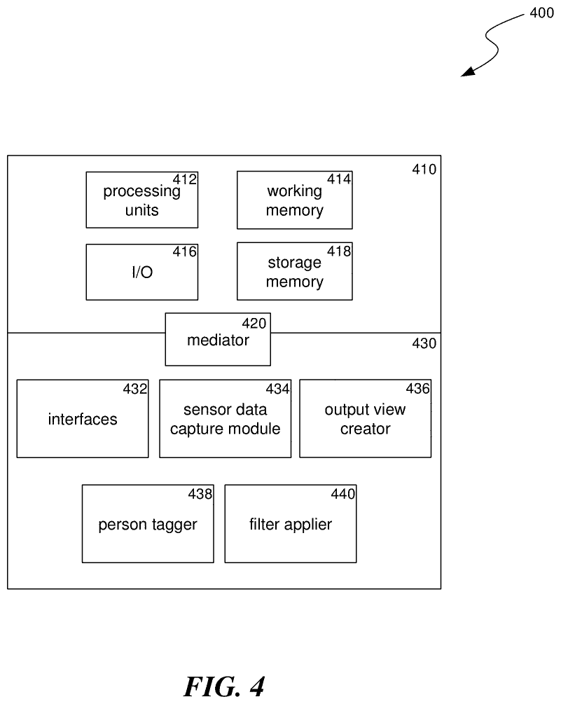

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for controlling how artificial reality devices capture and share surroundings information. Specialized components 430 can include sensor data capture module 434, output view creator 436, person tagger 438, filter applier 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

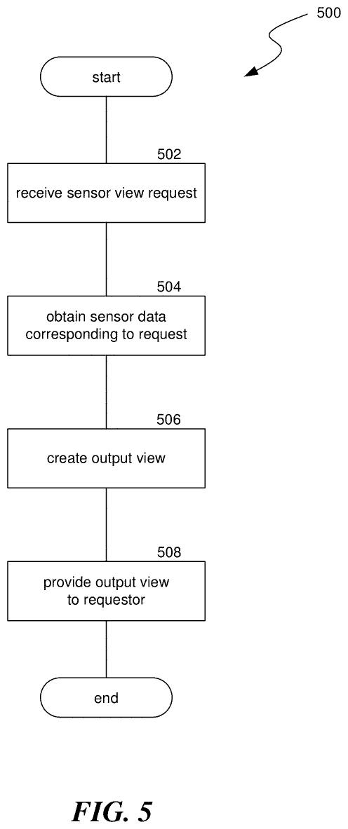

Sensor data capture module 434 can obtain sensor data corresponding to a sensor view request. This can include gathering image, depth, audio, or other data captured by an artificial reality device. Depending on whether the request is for a point-of-view or world-view output view, the obtained sensor data can be for the entire surrounding area of the artificial reality device or just the portion viewable by the artificial reality device user. Additional details on obtaining sensor data are provided below in relation to block 504 of FIG. 5.

Output view creator 436 can receive sensor data from sensor data capture module 434 and can format it as an output view. In various cases, this can include creating a world-view output view as a 3D model from the sensor data, flattening such a 3D model into an image or panoramic image, or creating a point-of-view output view by selecting or cropping the sensor data to reflect only the portion viewable to the artificial reality device user. Additional details on creating an output view are provided below in relation to block 508 of FIG. 5.

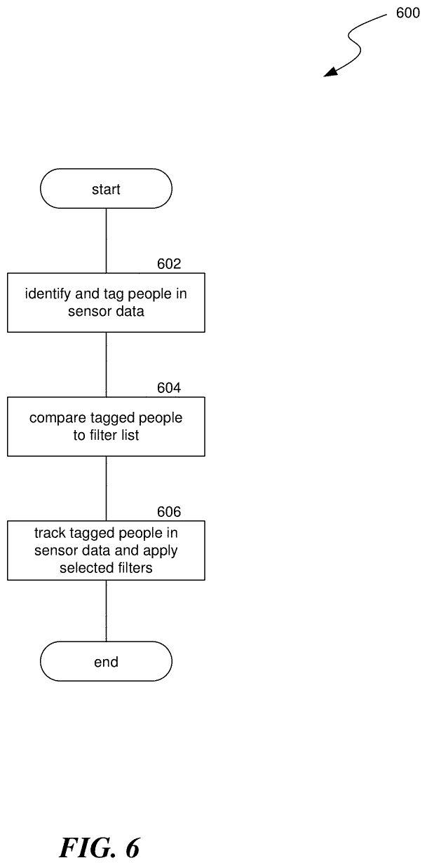

Person tagger 438 can identify and tag people depicted in sensor data, e.g., from sensor data capture module 434. In various implementations, person tagger 438 can accomplish this using e.g., techniques for facial recognition, body shape recognition, recognition of devices associated with depicted people, etc. Person tagger 438 can then tag portions of the sensor data (e.g., areas in images) with the corresponding user identifiers. Additional details on identifying and tagging a person in sensor data are provided below in relation to block 602 of FIG. 6.

Filter applier 440 can check whether users tagged by person tagger 438 satisfy a rule for applying a filter or are on a filter list, and if so, can apply a corresponding filter such as filters to blur, facial blur, apply an overlay (e.g., stickers, words, clothing, animations, makeup, etc.), morph part of persons, apply a shading or highlighting to the person, spatially associate content with the person (e.g., retrieve notes on a person and place them as related world-locked content), etc. Additional details on selecting and applying filters to tagged persons are provided below in relation to blocks 604 and 606 of FIG. 6.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for providing output views illustrating the captured sensor data of an artificial reality device. In some implementations, process 500 can be performed on an artificial reality device, while in other cases process 500 can be performed on a server system that receives sensor data from the artificial reality device.

At block 502, process 500 can receive a sensor view request. In various implementations, the sensor view request can be from an internal system (such as part of a setup process or an artificial reality device user activating a control to see what that device is capturing or to send the user's point-of-view to another system) or a request from an external device (such as a nearby user requesting to see if her image is being captured or a capture hub requesting the captures of devices in the area). When a request is from an external system, process 500 can include various privacy and authentication steps, such as getting requestor credentials to prove his identity, requesting the artificial reality device user's approval for the request, checking an allowed viewers list, etc. When the request is from a current artificial reality device user, it can include a selection of which users to send the resulting output view to and/or whether the resulting output view is publicly viewable or viewable to users with certain characteristics (such as those defined as the user's “friends” on a social graph).

At block 504, process 500 can obtain sensor data corresponding to the sensor view request. In various implementations, the sensor data can include image data, depth data (e.g., from a time-of-flight sensor, from multiple cameras that determine depth data for points based on a delta in their viewpoints, from a structured light system that projects a pattern of light and determines depth data from the pattern deformations, etc.), audio data, etc., from the surroundings of the artificial reality device. The sensor data can be from areas that are either or both inside and outside a point-of-view of a user of the artificial reality device. In some cases, the request can specify whether the output view should be a world-view or a point-of-view view. In other cases, process 500 can be configured to create just one of these views. When process 500 is creating a point-of-view output view, the sensor data can be just that portion that includes the area viewable by the user. As used herein, a “point-of-view” is an area of the display from the artificial reality device that the user can see. This is as opposed to a world-view, which includes all the areas that the artificial reality device can view, whether or not they are visible to the user.

At block 506, process 500 can create an output view. An output view is a displayable representation of sensor data gathered by an artificial reality device. Process 500 can create the output view, from sensor data obtained at block 504, forming a view into a 3D environment showing parts of the surroundings of the artificial reality device. In various implementations, the output view can be one or more images, a 3D model or mesh, a point cloud, a panoramic image, a video, etc. In some cases, e.g., when creating a world-view output view, process 500 can reconstruct the sensor data into a 3D model by translating sensor depth data into 3D positions relative to an origin (e.g., at the artificial reality device). In some cases, this 3D model or a pixel cloud can be the output view, while in other cases such a 3D model can be flattened into an image or panoramic image by taking a picture with a virtual camera (or 360 degree virtual camera) positioned at the location of the artificial reality device in relation to the 3D model or pixel cloud. In some implementations, such as some instances when the output view is a point-of-view output view, process 500 can create a live stream of the image data captured by the artificial reality device that is viewable by the artificial reality device user. In yet other cases, the point-of-view output view can be the portion of the world-view output view that aligns to the area of the world that the artificial reality device user can see.

At block 508, process 500 can provide the output view created at block 506 in response to the sensor view request. In various implementations, this can include displaying the created output view on the artificial reality device (e.g., when the request was from an internal system) or sending the output view to a third party (e.g., when the request was from a validated/authorized other user or system). In some cases, the output view can be provided to a central system (referred to herein as a “capture hub”) which other users can then access to see what is being captured by an individual device. In some cases, the capture hub can combine the output views from multiple artificial reality devices, allowing a viewing user to see which areas are being captured by one or more devices, and the combined output view may provide an indication (e.g., a border or colored shading) illustrating which device(s) are capturing which area(s). After providing the output view, process 500 can end.

FIG. 6 is a flow diagram illustrating a process 600 used in some implementations for adding person filters to captured sensor data. In various cases, process 600 can be performed on an artificial reality device or on a server system receiving sensor data from an artificial reality device.

At block 602, process 600 can identify and tag people depicted in sensor data. At block 602, process can e.g., analyze image data and device communication data, to apply various recognition techniques to recognize people such as facial recognition, body shape recognition, recognition of devices associated with depicted people, etc. The portions of the sensor data (e.g., areas in images) can be tagged with corresponding user identifiers. In addition, the images of users can be segmented (e.g., using machine learning body modeling techniques) such that portions of identified users, such as their heads or faces, torsos, arms, etc., can be individually masked for application of filters to portions of users.

At block 604, process 600 can compare the tags for persons identified in block 602 to a filter list to identify which should have filters applied. A filter list can be a set of mappings, defined by an artificial reality device user and/or defined by depicted persons, that specify which filters should be applied to particular persons or categories of persons. In some cases, the filter list can map individual person identities to filters. In other cases, the filter list can map categories of persons, such as friends of the current user as specified in a social graph, persons the current user has manually classified (e.g., reminders for people the current user wants to talk to), persons in a common social group with the current user as specified in a social graph, persons with or without verified authentications or privacy permissions set, etc. In some implementations, instead of using a filter list, rules can be applied to select filters for particular users. For example, an artificial reality device can determine, based on a user's gaze direction, their current focus, and a rule can indicate that users outside the user's gaze direction should have a blur filter applied. In various implementations, filters can apply any number of effects to a user, such as effects to: blur, facial blur, apply an overlay (e.g., stickers, words, clothing, animations, makeup, etc.), morph part of a person, apply a shading or highlighting to the person, spatially associate content with the person (e.g., retrieve notes on a person and place them as related world-locked content), etc.

At block 606, process 600 can track tagged people in the sensor data and apply the filters selected at block 604. In some implementations, filters can be applied to sensor data only when it is transferred off the artificial reality device (e.g., when shared from the artificial reality device as described in FIG. 5) or can be applied to a live view of the person viewed through the artificial reality device. In some cases, the filter can be performed as an addition to the sensor data while keeping the original sensor data (e.g., as an overlay), while in other cases the filters permanently edit the source sensor data (e.g., to obscure captured person images or apply privacy controls on the artificial reality device). Following application of the filters, process 600 can end.

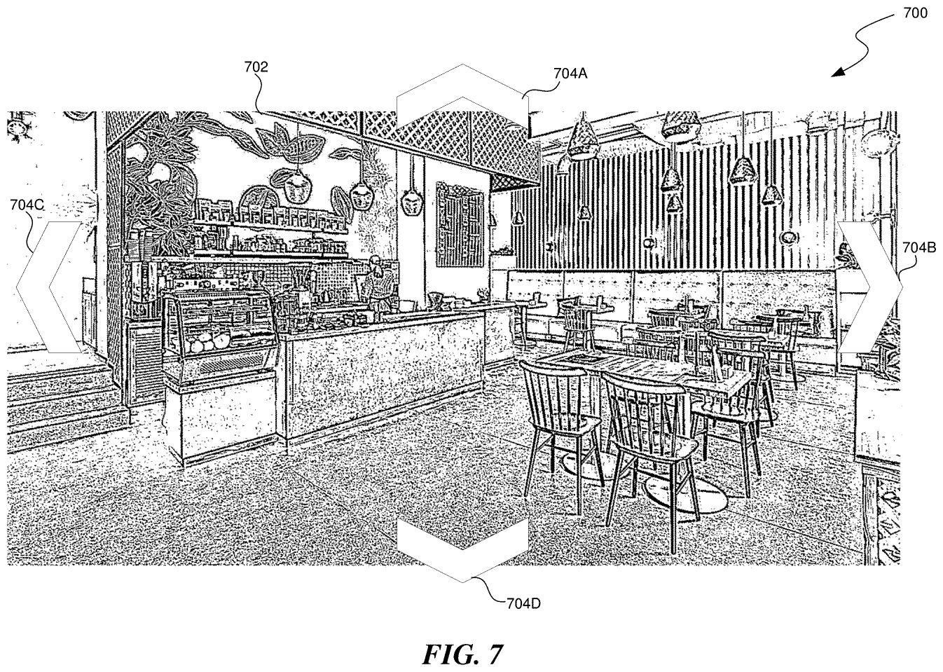

FIG. 7 is a conceptual diagram illustrating an example 700 of a world-view version of an output view from an artificial reality device. In example 700, the world-view shows a panoramic image 702 of an environment around an artificial reality device, based on depth images captured by the artificial reality device. The panoramic image 702 was created by flattening a 3D model from a point of view of the artificial reality device, where the 3D model was based on a point cloud captured by the artificial reality device, where each pixel had an associated depth. While example 700 shows a single view of the panoramic image 702, and thus just a part of the captured area around the artificial reality device, a viewing user can activate controls 704A-D to pan the panoramic image to view the remainder of the surrounding area captured by the artificial reality device.

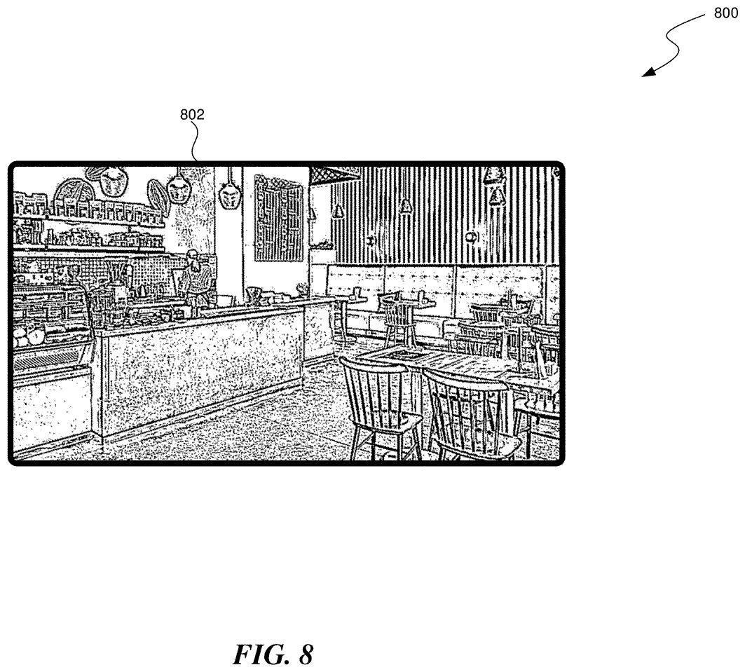

FIG. 8 is a conceptual diagram illustrating an example 800 of a point-of-view version of an output view from an artificial reality device. In example 800, the point-of-view view is an image 802 of a portion of an environment around an artificial reality device that is viewable to a user of the artificial reality device. The image 802 was created by cropping a world-view output view (as discussed above in FIG. 7) to only the portion that corresponds to a display area of the artificial reality device. Thus, image 802 shows the portion of the surroundings to which the artificial reality device can add virtual objects for the user to view. As the artificial reality device user moves the artificial reality device, the image 802 can be updated to illustrate the current viewable area of the user.

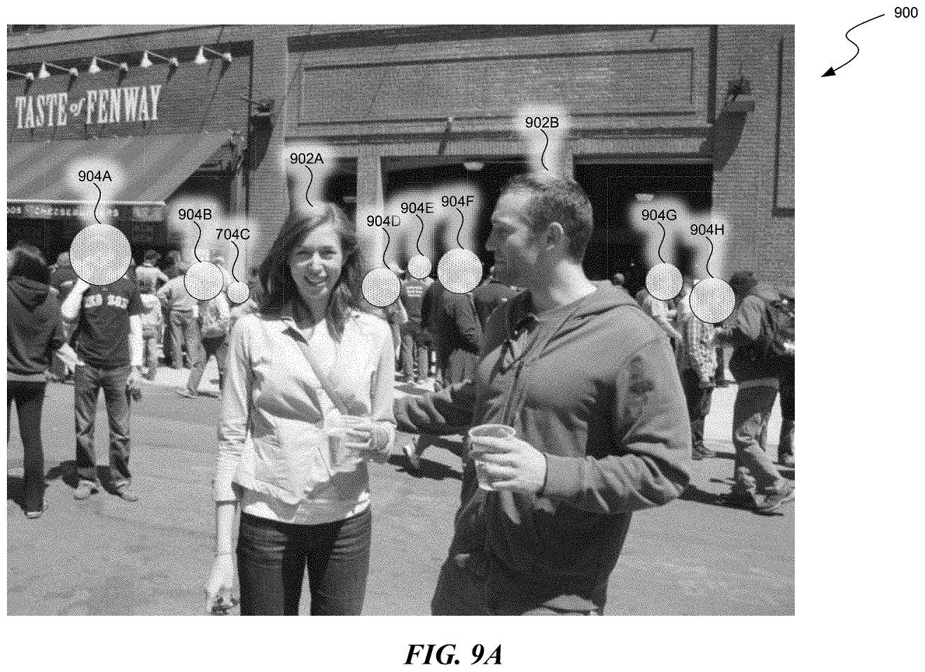

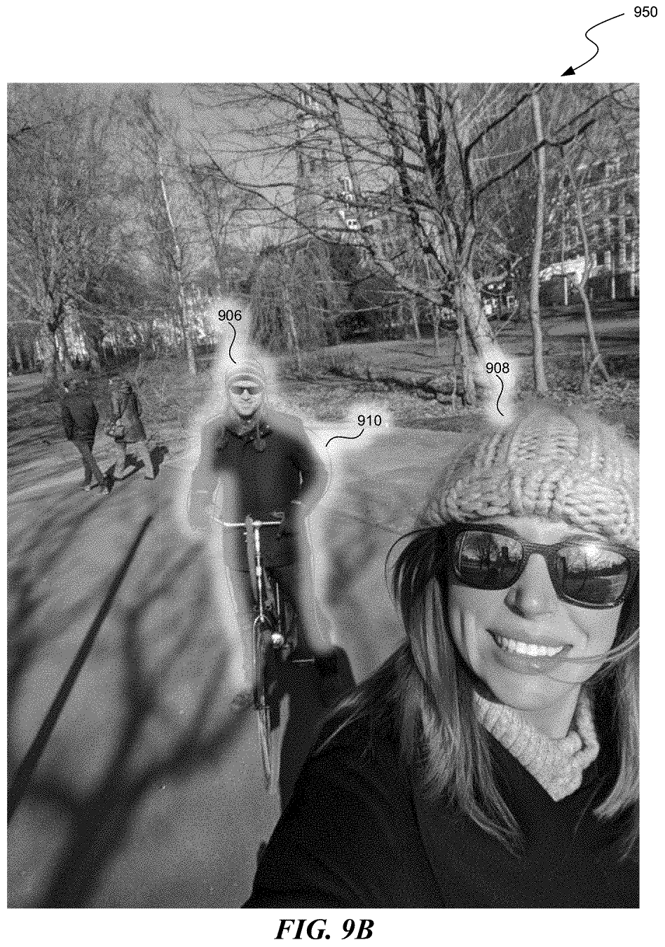

FIG. 9A is a conceptual diagram illustrating a first example 900 of a person filter modifying the view of people captured by an artificial reality device. In example 900, an artificial reality device has determined that the current focus of the user of the artificial reality device is on persons 702A and 702B (e.g., based on the user's gaze direction and social context with these people). The artificial reality device has also identified multiple other people in view. Based on a rule that non-focus people's faces should have a blur effect applied, the artificial reality device has applied blur effects 704A-H to the faces of the non-focus people.

FIG. 9B is a conceptual diagram illustrating a second example 950 of a person filter modifying the view of a person captured by an artificial reality device. In example 950, an artificial reality device has captured an image depicting several people. The artificial reality device has recognized and tagged people 702 and 704. By comparing these tags to a list of people for whom the artificial reality device user has indicated she would like a reminder, the artificial reality device has determined that the user 702 is on the list. In response, the artificial reality device has applied a highlighting overlay filter the user 702, causing the artificial reality device user to see highlighting 706, reminding her that user 702 is on her list.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1. A method for capturing and sharing surroundings information of an artificial reality device, the method comprising:
receiving, at the artificial reality device, a request to view sensor data captured by the artificial reality device;
obtaining sensor data corresponding to the request, wherein the sensor data comprises image data showing surroundings of the artificial reality device that are both inside and outside a point-of-view of a user of the artificial reality device;
creating an output view, from the obtained sensor data, comprising a view into a 3D environment showing parts of the surroundings of the artificial reality device detected and reconstructed by the artificial reality device; wherein the output view is created by:
creating a first image showing a first portion of the surroundings, wherein the first portion includes parts of the surroundings that are both inside and outside the point-of-view of the user, and
selecting, as the output view, either the first image or a second image, wherein the second image is a second portion of the first image that excludes the parts of the surroundings that are outside the point-of-view of the user; and
providing the output view in response to the request.

2. The method of claim 1, wherein the request originated from a user of the artificial reality device.

3. The method of claim 1,
wherein the request originated from a system external to the artificial reality device, and
wherein the output view is provided to a viewing user via a capture hub where the viewing user accesses a view based on two or more output views, wherein at least one of the two or more output views is from a second artificial reality device.

4. The method of claim 1 further comprising, prior to providing the output view in response to the request, obtaining authorization to share the output view from a user of the artificial reality device.

5. The method of claim 1, wherein the output view is a 3D model of at least a portion of an area surrounding the artificial reality device.

6. The method of claim 1, wherein the output view is a point cloud of at least a portion of an area surrounding the artificial reality device.

7. The method of claim 1, wherein the output view is a panoramic image, of at least one portion of an area surrounding the artificial reality device, created by flattening a portion of a 3D model depicting the at least one portion of the area surrounding the artificial reality device.

8. The method of claim 1 further comprising:
identifying and tagging one or more people depicted in the sensor data;
comparing the tagged one or more people to a filter list to identify at least one person with a set filter; and
applying the set filter to a depiction of the at least one person to change an appearance of the at least one person in the output view.

9. The method of claim 8, wherein the set filter obscures at least a face of the at least one person.

10. A non-transitory computer-readable storage medium storing instructions that, when executed by a computing system, cause the computing system to perform a process for sharing surroundings information of an artificial reality device, the process comprising:
receiving, at the artificial reality device, a request to view sensor data captured by the artificial reality device;
obtaining sensor data corresponding to the request, wherein the sensor data comprises image data showing surroundings of the artificial reality device that are both inside and outside a point-of-view of a user of the artificial reality device;
creating an output view, from the obtained sensor data, comprising a view into a 3D environment showing parts of the surroundings of the artificial reality device detected by the artificial reality device; wherein the output view is created by:
creating a first image showing a first portion of the surroundings, wherein the first portion includes parts of the surroundings that are both inside and outside the point-of-view of the user, and
selecting, as the output view, either the first image or a second image, wherein the second image is a second portion of the first image that excludes the parts of the surroundings that are outside the point-of-view of the user; and
providing the output view in response to the request.

11. The non-transitory computer-readable storage medium of claim 10, wherein the request originated from a system external to the artificial reality device.

12. The non-transitory computer-readable storage medium of claim 10, wherein the output view is a 3D model of at least a portion of an area surrounding the artificial reality device.

13. The non-transitory computer-readable storage medium of claim 10, wherein the output view is a point cloud of at least a portion of an area surrounding the artificial reality device.

14. The non-transitory computer-readable storage medium of claim 10, wherein the output view is a panoramic image, of at least one portion of an area surrounding the artificial reality device, created by flattening a portion of a 3D model depicting the at least one portion of the area surrounding the artificial reality device.

15. The non-transitory computer-readable storage medium of claim 10, wherein the process further comprises:
identifying and tagging one or more people depicted in the sensor data;
comparing the tagged one or more people to a filter list to identify at least one person with a set filter; and
applying the set filter to a depiction of the at least one person to change an appearance of the at least one person in the output view.

16. The non-transitory computer-readable storage medium of claim 15, wherein the set filter obscures at least part of the at least one person.

17. A computing system for sharing surroundings information of an artificial reality device, the computing system comprising:
one or more processors; and
one or more memories storing instructions that, when executed by the one or more processors, cause the computing system to perform a process comprising:
receiving, at the artificial reality device, a request to view sensor data captured by the artificial reality device;
obtaining sensor data corresponding to the request, wherein the sensor data comprises image data showing surroundings of the artificial reality device that are both inside and outside a point-of-view of a user of the artificial reality device;
creating an output view, from the obtained sensor data, comprising a view into a 3D environment showing parts of the surroundings of the artificial reality device detected by the artificial reality device; wherein the output view is created by:
creating a first image showing a first portion of the surroundings, wherein the first portion includes parts of the surroundings that are both inside and outside the point-of-view of the user, and
selecting, as the output view, either the first image or a second image, wherein the second image is a second portion of the first image that excludes the parts of the surroundings that are outside the point-of-view of the user; and
providing the output view in response to the request.

18. The computing system of claim 17, wherein the output view is a 3D model of at least a portion of an area surrounding the artificial reality device.

19. The computing system of claim 17, wherein the output view is a panoramic image, of at least one portion of an area surrounding the artificial reality device, created by flattening a portion of a 3D model depicting the at least one portion of the area surrounding the artificial reality device.

20. The computing system of claim 17, wherein the process further comprises:
identifying and tagging one or more people depicted in the sensor data;
comparing the tagged one or more people to a filter list to identify at least one person with a set filter; and
applying the set filter to a depiction of the at least one person to change an appearance of the at least one person in the output view.
